(19) United States
(12) Patent Application Publication
(10) Pub. No.: US 2025/0042482 A1
(43) Pub. Date: Feb. 6, 2025

(54) Aerodynamic Package for a Land Vehicle

(71) Applicant: ESS 2 Tech, LLC, Bethlehem, PA (US)

(72) Inventors: MICHAEL SUK, Milton, PA (US); David A. Shoffler, Marion Heights, PA (US)

(73) Assignee: ESS 2 Tech, LLC, Bethlehem, PA (US)

(21) Appl. No.: 18/363,888

(22) Filed: Aug. 2, 2023

(51) Int. Cl. B62D 35/00

(52) U.S. Cl. CPC B62D 35/005; B62D 35/007

(57) ABSTRACT

An air diffuser configured for use at the lower rear of an land vehicle may include an airfoil that, when located at the lower rear of a land vehicle, is oriented to redirect air passing under the vehicle upward behind the vehicle when the vehicle is traveling in a forward direction. The airfoil may have a leading edge, a trailing edge, an upper side, and a lower side, the airfoil cross-sectional shape including: a base portion including a first surface associated with the upper side and a second surface associated with the lower side; an overhang portion that extends under some of the base portion; and an elliptic portion connecting the base portion and the overhang portion adjacent the leading edge.

### BACKGROUND OF THE INVENTION

The present invention relates generally to an aerodynamic package for a land vehicle and, more particularly, to the implementation of a particular airfoil shape for a front wing, rear wing, and rear diffuser of a land vehicle.

Aerodynamic management of airflow is a critical aspect of vehicle design and, in particular, with respect to racecars because it comes into play so significantly at high speeds. Racecars commonly utilize a rear wing mounted at the upper rear of the vehicle for producing downforce in order to improve grip between the tires and the track surface. The trailing edge of a rear wing may be angled upward in order to produce more downforce. However, this comes at an expense, namely increased drag.

A front wing, typically implemented at the lower front of an open wheel racecar has the same competing concerns (i.e., downforce vs. drag). In addition, a front wing is also utilized to manage the split of airflow over the racecar and under the racecar. It is generally desirable to increase the flow of air beneath a racecar that has a low ride height because the increased flow of air under a low riding car produces downforce as the air accelerates through the small space between the vehicle undercarriage and the track surface. However, this is a competing concern with downforce. For a typical front wing, the trailing edge of the wing is angled upward to produce downforce, but this forces most of the air over the car, and little air under the car. So, downforce is produced by the front wing itself, but not much is produced from the air flowing under the car.

A rear air diffuser is utilized at the lower rear of a racecar to smooth the flow of air coming from under the car and to direct the air flow upward into the void behind the racecar in order to reduce drag. However, a rear diffuser can only redirect the air upward so much without producing a significant amount of drag. In addition, there is a disconnect between the air flowing over the car and the air flowing under the car.

The disclosed aerodynamic system and components address one or more of the issues discussed above.

### SUMMARY OF THE INVENTION

The present disclosure is directed to the implementation of a particular airfoil shape in various aerodynamic components of a racecar, sports car, or other type of land vehicle. For example, the airfoil may be used as part of a rear diffuser at the lower rear of the car. Alternatively, or additionally, the airfoil may be used as a rear wing to produce downforce at the rear of the car. Further, for open wheel racecars, the airfoil may be used to form a front wing to produce downforce at the front of the car. In some cases, a front wing of the disclosed design may even be used on a closed wheel vehicle.

In one aspect, the present disclosure is directed to an air diffuser configured for use at the lower rear of a land vehicle, comprising: an airfoil that, when located at the lower rear of a land vehicle, is oriented to redirect air passing under the land vehicle upward behind the land vehicle when the land vehicle is traveling in a forward direction. The airfoil may have a leading edge, a trailing edge, an upper side, and a lower side, the airfoil cross-sectional shape including: a base portion including a first surface associated with the upper side and a second surface associated with the lower side; an overhang portion that extends under some of the base portion; and an elliptic portion connecting the base portion and the overhang portion adjacent the leading edge.

In another aspect, the present disclosure is directed to a front wing configured for use at the lower front of a land vehicle, comprising: an airfoil that, when located at the lower front of a land vehicle, is oriented to control the ratio of air directed over the land vehicle when the land vehicle is traveling in a forward direction to air directed under the land vehicle when the land vehicle is traveling in a forward direction. The airfoil may have a leading edge, a trailing edge, an upper side, and a lower side, the airfoil cross-sectional shape including: a base portion including a first surface associated with the upper side and a second surface associated with the lower side; an overhang portion that extends under some of the base portion; and an elliptic portion connecting the base portion and the overhang portion adjacent the leading edge. The overhang portion may be curved toward the second surface of the base portion.

In another aspect, the present disclosure is directed to a rear wing configured for use at the upper rear of a land vehicle, comprising: an airfoil that, when located at the upper rear of a land vehicle, is oriented to produce downforce when the land vehicle is traveling in a forward direction. The airfoil may include a leading edge, a trailing edge, an upper side, and a lower side, the airfoil cross-sectional shape including: a base portion including a first surface associated with the upper side and a second surface associated with the lower side; an overhang portion that extends under some of the base portion; and an elliptic portion connecting the base portion and the overhang portion adjacent the leading edge. The overhang portion may be curved toward the second surface of the base portion.

In another aspect, the present disclosure is directed to a land vehicle having an aerodynamic system, comprising: a rear air diffuser positioned at the lower rear of the land vehicle and configured to redirect airflow from under the land vehicle upward behind the land vehicle while the land vehicle is traveling in a forward direction; and a rear wing positioned at the upper rear of the land vehicle and configured to generate downforce when the land vehicle is traveling in a forward direction. The rear air diffuser and the rear wing may be configured and arranged to merge the flow of air from underneath the land vehicle with the flow of air from above the land vehicle.

In another aspect, the present disclosure is directed to a land vehicle having an aerodynamic system, comprising: a front wing positioned at the lower front of the land vehicle and configured to split the flow of air over and under the land vehicle while the land vehicle is traveling in a forward direction; and a rear air diffuser positioned at the lower rear of the land vehicle and configured to redirect airflow from under the land vehicle upward behind the land vehicle while the land vehicle is traveling in a forward direction. The front wing and the rear air diffuser may work together to control the flow of air underneath the land vehicle.

In another aspect, the present disclosure is directed to a land vehicle having an aerodynamic system, comprising: a front wing positioned at the lower front of the land vehicle and configured to split the flow of air over and under the land vehicle while the land vehicle is traveling in a forward direction; and a rear wing positioned at the upper rear of the land vehicle and configured to generate downforce when the land vehicle is traveling in a forward direction. The front wing and the rear wing may work together to control the flow of air over the land vehicle.

In another aspect, the present disclosure is directed to a land vehicle having an aerodynamic system, comprising: a front wing positioned at the lower front of the land vehicle and configured to split the flow of air over and under the land vehicle while the land vehicle is traveling in a forward direction; a rear wing positioned at the upper rear of the land vehicle and configured to generate downforce when the land vehicle is traveling in a forward direction; and a rear air diffuser positioned at the lower rear of the land vehicle and configured to redirect airflow from under the land vehicle upward behind the land vehicle while the land vehicle is traveling in a forward direction. The front wing, the rear wing, and the rear air diffuser may work together to control the flow of air over and under the land vehicle.

Other systems, methods, features, and advantages of the invention will be, or will become, apparent to one of ordinary skill in the art upon examination of the following figures and detailed description. It is intended that all such additional systems, methods, features, and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic isometric view of an embodiment of an airfoil along the pressure side;

FIG. 2 is a schematic isometric view of a suction side of the airfoil of FIG. 1;

FIG. 3 is a schematic side view of an embodiment of an airfoil;

FIG. 4 is a schematic side view of the airfoil of FIG. 3, in which the curvature of various portions of the airfoil are indicated;

FIG. 5 is a schematic view of an embodiment of an airfoil indicating pathlines of airflow elements;

FIG. 6 is a schematic illustration of an open wheel racecar implementing a front wing, rear wing, and rear air diffuser all having an airfoil shape in accordance with that shown in FIGS. 1-5;

FIG. 7 is a schematic perspective illustration of a rear air diffuser assembly according to an exemplary embodiment;

FIG. 8 is a schematic exploded view of the rear air diffuser of FIG. 7;

FIG. 9 is a schematic cutaway cross-sectional view of the rear air diffuser of FIG. 7;

FIG. 10 is a schematic cutaway cross-sectional view of a front wing according to an exemplary embodiment;

FIG. 11 is a schematic cutaway cross-sectional view of a rear wing according to an exemplary embodiment;

FIG. 12 is a block diagram illustrating exemplary components of an active aerodynamic system according to an exemplary embodiment; and

FIG. 13 is a flowchart illustrating steps of an exemplary method of operating the system shown in FIG. 12.

### DETAILED DESCRIPTION

The present disclosure is directed to systems that implement airfoils having hooked cross-sectional shapes. The airfoils of the disclosed embodiments may implement one or more airfoil shapes described in Suk et al., U.S. Pat. No. 10,766,544, issued on Sep. 8, 2020, and entitled “Airfoils and Machines Incorporating Airfoils,” the entire disclosure of which is incorporated herein by reference.

As used herein, the term “airfoil” (or “aerofoil”) is any structure with curved surfaces that produces an aerodynamic force when moved through a fluid. As used herein, the term “fluid” may refer to any Newtonian Fluid. In other embodiments, airfoils could be used with Non-Newtonian Fluids.

An airfoil may include an upper or suction surface against which fluid flows at a relatively high velocity with low static pressure. An airfoil may also include a lower or pressure surface that has a high static pressure relative to the suction surface. Alternatively, the suction and pressure surfaces could be referred to as suction and pressure sides. It will also be understood that the “upper” and “lower” surfaces may be reversed for implementations where the airfoil is used in an inverted orientation.

The airfoil also includes a leading edge defined as the point at the front of the airfoil with maximum curvature. The airfoil also includes a trailing edge defined as the point at the rear of the airfoil with minimum curvature. In addition, a chord line of the airfoil refers to a straight line between the leading and trailing edges. Also, a mean camber line is the locus of points midway between the upper and lower surfaces and may or may not correspond with the chord line depending on the shape of the airfoil.

As used herein, an airfoil has a chord length defined as the length of the airfoil's chord line. In addition, the airfoil has a thickness defined as the distance between the upper and lower surfaces along a line perpendicular to the mean camber line. The width of an airfoil is taken in a direction perpendicular to both the chord line and the thickness.

Throughout the specification and claims the term “radius of curvature” is used. The radius of curvature is the reciprocal of the curvature at a particular location on a curve or two-dimensional surface. For a curve, the radius of curvature equals the radius of the circular arc that best approximates the curve at that point. In particular, it should be noted that the larger the radius of curvature of a curve, the smaller the curvature (and vice versa).

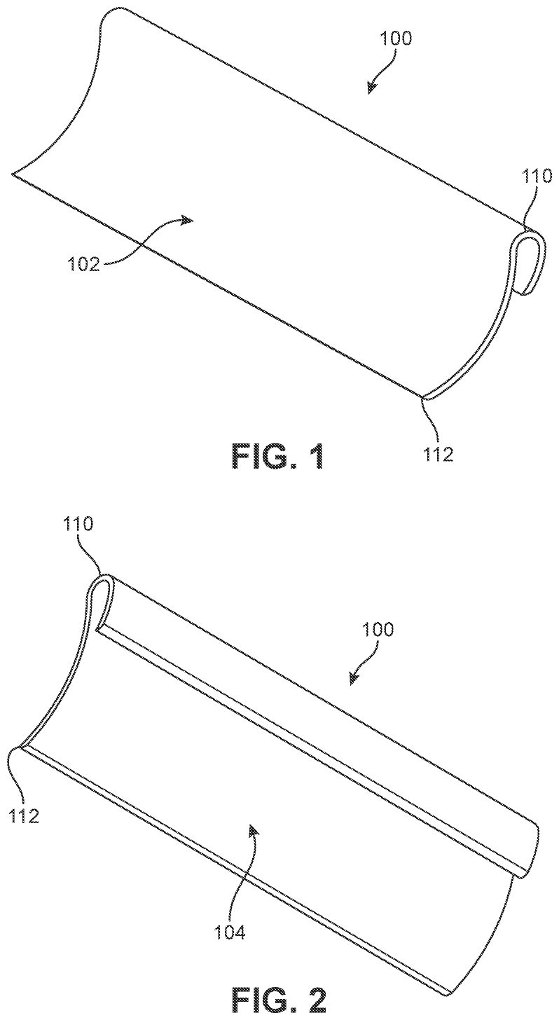

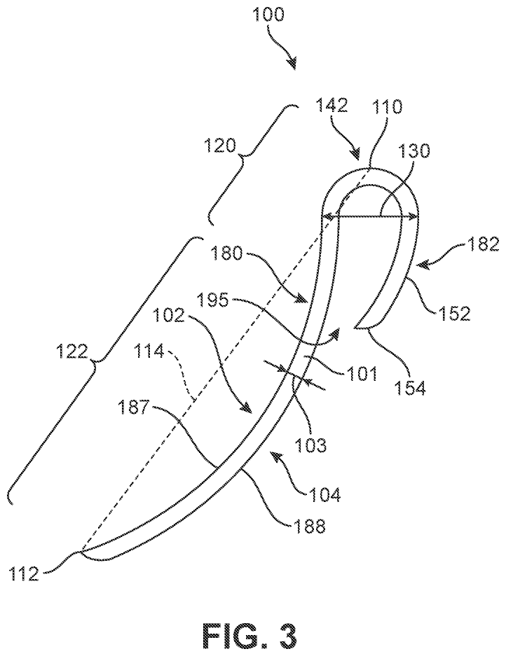

FIGS. 1-2 illustrate schematic isometric views of an airfoil (or blade) 100, while FIG. 3 illustrates a schematic side view of airfoil 100. Referring to FIGS. 1-3, airfoil 100 is comprised of a pressure side 102 (shown in FIG. 1) and an opposing suction side 104 (shown in FIG. 2). Each of these sides includes a surface (e.g., a pressure surface or a suction surface) in contact with air during operation. Additionally, airfoil 100 includes a leading edge 110 and a trailing edge 112. Moreover, leading edge 110 and trailing edge 112 are connected by a chord line 114 (see FIG. 3).

Referring to FIG. 3, in some embodiments, airfoil 100 may be comprised of a single body 101 of material. In some embodiments, airfoil 100 may be formed of a single unitary piece of material. Starting from trailing edge 112, body 101 includes a base portion 180 that is seen to curve gradually through the length of airfoil 100. Base portion 180 includes first a surface 187 on pressure side 102 of airfoil 100 and an opposing second surface 188 on opposing suction side 104.

At the end of base portion 180, body 101 bends to create a folded or hook-like section adjacent leading edge 110. That is, adjacent leading edge 110, body 101 is comprised of an elliptic portion 142 as well as an overhang portion 182 that hangs or extends over some of base portion 180. Elliptic portion 142 connects base portion 180 and overhang portion 182 and also includes leading edge 110.

In some embodiments, overhang portion 182 may be spaced apart or separated from base portion 180. In the embodiment of FIG. 3, overhang portion 182 is separated from base portion 180 by gap 195. In different embodiments, the size of gap 195 may vary. In some cases, gap 195 may be greater than or equal to a thickness of overhang portion 182. In some cases, gap 195 may be at least three times as large as a thickness of overhang portion 182. The size of gap 195, and thus, the spacing of overhang portion 182 from base portion 180, determines the airflow behavior across airfoil 100. Accordingly, as discussed in further detail below, gap 195 may be sized accordingly to provide the desirable airflow behavior.

The fold in body 101 adjacent leading edge 110 may be seen to divide airfoil 100 into two portions having distinctive geometries: a leading airfoil portion 120 and a trailing airfoil portion 122. As shown in FIG. 3, leading airfoil portion 120 is formed by the elliptic portion 142, the overhang portion 182, and the leading segment of base portion 180. Trailing airfoil portion 122 is formed by the trailing segment of base portion 180.

In different embodiments, the length of leading airfoil portion relative to the overall length of the airfoil (that is, the percent of the total airfoil length that the overhang portion extends over) can vary. In some cases, the leading airfoil portion has a relative length of 25 to 50 percent of the total airfoil length. In one embodiment, the leading airfoil portion has a length of at least 25 percent of the total airfoil length. In yet another embodiment, the leading airfoil portion has a length of at least one third of the total airfoil length. In some cases, the leading airfoil portion may made sufficiently long enough (at least 25 percent or so of the total airfoil length) so that the first arc portion can be gradually curved down towards the second arc portion, thereby helping to keep the boundary layer attached to the airfoil before the dramatic step down in thickness adjacent the second arc portion.

As seen in FIG. 3, body 101 has a relatively constant local thickness 103 throughout airfoil 100. However, the folded shape of body 101 that forms overhang portion 182 provides a greater overall thickness through leading airfoil portion 120 than in trailing airfoil portion 122. Here, the overall thickness is measured between opposing suction side 104 and pressure side 102 and is distinct from the local body thickness. Specifically, leading airfoil portion 120 has variable thickness 130 with a maximum value adjacent leading edge 110 and a minimum value at a location furthest from leading edge 110. In contrast, trailing airfoil portion 122 has an approximately constant thickness. In some embodiments, the thickness of trailing airfoil portion 122 is approximately equal to local thickness 103 of body 101. In other embodiments, trailing airfoil portion 122 could also have a variable thickness.

An airfoil may include provisions for keeping airflow “stuck” on the suction surface so that the air can be redirected through a large angle (e.g., from a near horizontal direction for incoming air to a near vertical direction for outgoing air). In some embodiments, an airfoil can include a leading airfoil portion that includes one or more arcs for controlling the flow of air along a suction surface.

In some embodiments, overhang portion 182 may be further comprised of a first arc portion 152 and a second arc portion 154. First arc portion 152 may extend from elliptic portion 142, while second arc portion 154 may be disposed at an open or free end of overhang portion 182. In some embodiments, the curvature (along opposing suction side 104) of overhang portion 182 may vary from first arc portion 152 to second arc portion 154. In some cases, first arc portion 152 may be configured to curve down in the direction of base portion 180. Moreover, second arc portion 154 may be configured with steeper curvature that is also directed downwardly toward base portion 180.

In the following description the radius of curvature of various surfaces is defined relative to the length of a unit radius, denoted as “UN.” In different embodiments, the particular value of the length of the unit radius could vary. For example, the unit radius could have a length of 100 mm (i.e., 1 UN=100 mm), 6 inches (i.e., 1 UN=6 inches), or any other value. It may be understood that the ratio of two radii of curvature is independent of the particular value of the unit radius. Thus, if a first surface has a radius of curvature of 1 UN and a second surface has a radius of curvature of 0.5 UN, the ratio is equal to 1 divided by 0.5, or 2, and is a dimensionless quantity that is independent of the particular length of the unit radius in a given embodiment.

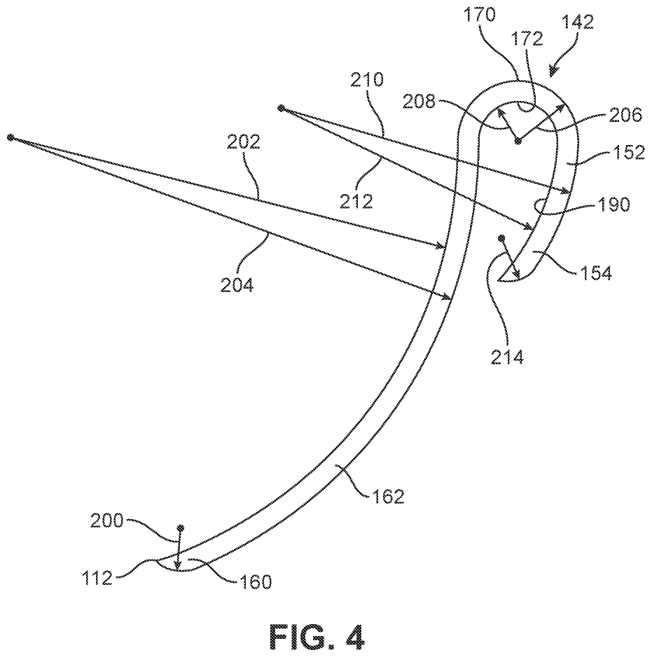

FIG. 4 is a schematic side view of airfoil 100. Referring to FIG. 4, the different portions or segments of airfoil 100 can have different degrees of curvature. In some embodiments, trailing airfoil portion 122 has trailing arc portion 160 immediately adjacent trailing edge 112. Trailing arc portion 160 has a radius of curvature 200. In some cases, radius of curvature 200 could have a value of approximately 0.1000 UN. In some embodiments, main segment 162 of trailing airfoil portion 122 has a radius of curvature 202 along pressure side 102 and a radius of curvature 204 along opposing suction side 104. In some cases, radius of curvature 202 has a value of approximately 1.1250 UN. In some cases, radius of curvature 204 has a value of approximately 1.1750 UN. In some embodiments, elliptic portion 142 has a radius of curvature 206 on outward facing side 170 and a radius of curvature 208 on inward facing side 172. In some cases, radius of curvature 206 has a value of approximately 0.1500 UN. In some cases, radius of curvature 208 has a value of approximately 0.1000 UN.

In some embodiments, first arc portion 152 has a radius of curvature 210 along opposing suction side 104 and a radius of curvature 212 along inward facing surface 190. In some cases, radius of curvature 210 has a value of approximately 0.7500 UN. In some cases, radius of curvature 212 has a value of approximately 0.7000 UN. In addition, second arc portion 154 has a radius of curvature 214. In some cases, radius of curvature 214 has a value of approximately 0.1000 UN.

Extrapolating the ratios above, in some embodiments, the ratio between radius of curvature 210 and radius of curvature 204 may be (0.7500 UN)/(1.175 UN)=0.638. Put another way, the radii of the curvatures of the suction side surface may be related such that the overhang portion has a smaller radius of curvature than the suction side of the trailing airfoil portion. In particular, if the radius of curvature 204 is 1.000 UN, then radius of curvature 210 may be 0.638 UN. Considering this ratio in reverse, if the radius of curvature 210 is 1.000 UN, then radius of curvature 204 may be 1.5667 UN. Generalizing, on the suction side of the airfoil, the radius of curvature of the overhang portion may be approximately two thirds that of the trailing airfoil portion. This smaller radius of curvature of the overhang portion curves the overhand portion toward the trailing airfoil portion, thus narrowing the gap between the tip of the overhang and the trailing airfoil portion.

In some embodiments, the curvature of each segment of airfoil 100 may be selected to help keep the boundary layer of flowing air attached to opposing suction side 104, even as airfoil 100 curves from leading edge 110 to trailing edge 112.

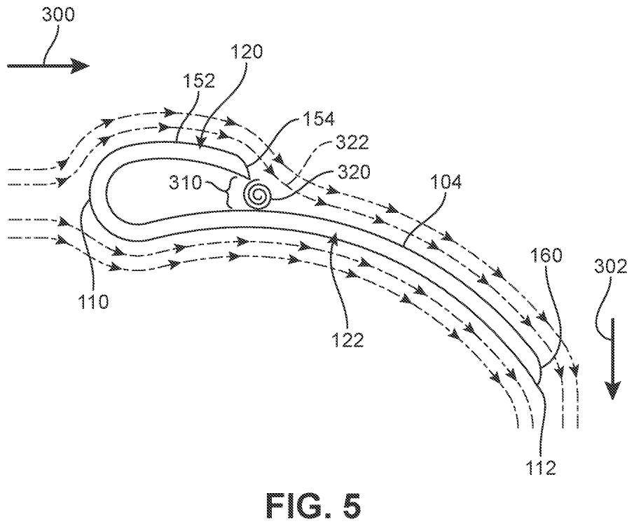

FIG. 5 is a schematic view of airfoil 100 in operation as air passes across it. Referring to FIG. 5, incoming air flows in a first direction 300 and encounters leading edge 110 first. Air moving across opposing suction side 104 will first pass across first arc portion 152, which curves to second arc portion 154. Air then gets directed into trailing airfoil portion 122. As the air flows along trailing airfoil portion 122, it is directed to trailing arc portion 160 and turns as it leaves trailing edge 112.

The geometry of leading airfoil portion 120 creates step-down region 310 resulting in an abrupt change in thickness between leading airfoil portion 120 and trailing airfoil portion 122. This sudden change in thickness (and geometry) creates vortex 320 (and/or turbulent eddies) at step-down region 310. As air flows over opposing suction side 104, vortex 320 “pulls” the air toward the airfoil and thereby reattaches the boundary layer of the flow as it moves from one section of the airfoil to the next, keeping the air “stuck” on opposing suction side 104.

The embodiments utilize specifically curved arc portions adjacent step-down region 310 to help actively control the turbulent eddies or vortices that develop at step-down region 310. Specifically, first arc portion 152 and second arc portion 154 combine to actively redirect the fluid flow with use of the Coandă effect toward reattachment to the airfoil surface. The Coandă effect refers to the tendency of a jet of fluid emerging from an orifice to follow an adjacent flat or curved surface and to entrain fluid from the surroundings so that a region of lower pressure develops. Vortex 320 (and/or turbulent eddies) at step-down region 310 creates a pressure difference between second arc portion 154 and trailing airfoil portion 122. The active fluid flowing across opposing suction side 104 creates an air curtain 322 (via the Coanda effect) that helps hold vortex 320 in place and keeps it attached to opposing suction side 104. Air curtain 322 thus provides a stabilizing force to keep vortex 320 in place, which further serves to prevent the boundary layer from delaminating from airfoil 100.

This arrangement provides an airfoil that keeps the airflow stuck to opposing suction side 104 enough to turn the airflow direction by as much as 90 degrees or more. That is, air initially flowing in first direction 300 as it encounters leading edge 110 leaves trailing edge 112 traveling in a second direction 302. In some cases, second direction 302 may be approximately 90 degrees from first direction 300. Thus, the airfoil will be forced in a direction that is substantially opposite of first direction 302. In other embodiments, depending on the shape and local curvature of various segments of airfoil 100, the direction of incoming air could be changed by any amount between approximately 10 degrees and approximately 110 degrees.

In different embodiments, the disclosed airfoils could be manufactured from various materials. Exemplary materials include, but are not limited to, materials known for use in automotive manufacturing, such as for example aluminum, fiberglass, composite materials (e.g., carbon fiber, carbon fiber reinforced plastic (CFRP)), steel, titanium, as well as other materials.

Airfoils can be manufactured using any known methods. In some embodiments, an airfoil can be formed using an extrusion process. In some embodiments, such airfoils may be formed using additive manufacturing (e.g., 3D printing).

The dimensions of an airfoil can vary according to its intended application. The chord line length, width, and thickness can all be varied in different ratios while maintaining the general profile shape of the airfoil.

The general airfoil design shown and discussed with respect to FIGS. 1-5 may be implemented in one or more aerodynamic components of a land vehicle, such as a racecar, sports car, or any other vehicle that makes use of aerodynamic componentry. In particular, the following disclosure will cover the implementation of the major components of racecars, including open wheel racecars, such as a front wing, rear wing, and rear air diffuser. It will be understood, however, that the described components may be utilized for closed wheel racecars and/or for road cars, that is, land vehicles used on the street as opposed to a racetrack. Therefore, the terms “land vehicle,” “vehicle,” “automobile,” and “car,” as used throughout this specification and the accompanying claims shall refer to all three, i.e., open wheel racecars, closed wheel racecars, and road cars. It will be further understood that these terms shall refer not only to “cars” such as sedans and coupes, but also to trucks, to the extent such vehicles may benefit from the disclosed aerodynamic components.

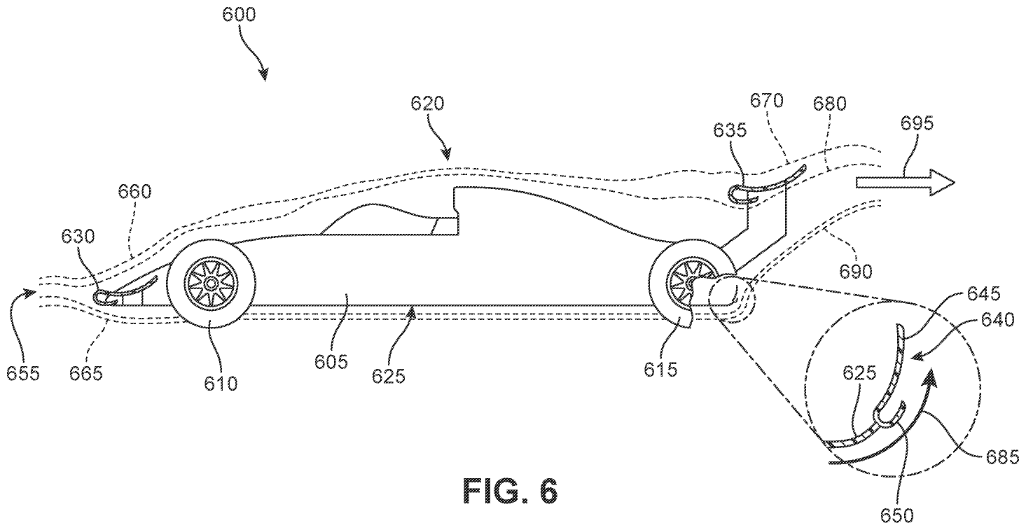

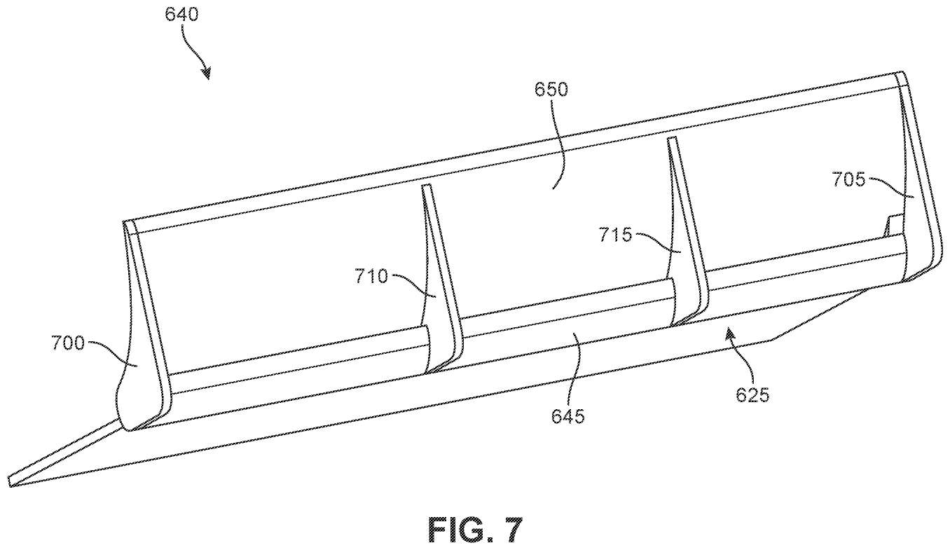

FIG. 6 is a schematic illustration of an open wheel racecar implementing a front wing, rear wing, and rear air diffuser all having an airfoil shape in accordance with that shown in FIGS. 1-5. As shown in FIG. 6, a racecar 600 may include a body 605, a front set of wheels 610 and a rear set of wheels 615. Racecar 600 also has a top side 620 and an underside 625.

As also shown in FIG. 6, racecar 600 may include a front wing 630, a rear wing 635, and a rear air diffuser 640. Front wing 630 may be positioned at a lower front of the vehicle and configured to split the flow of air over and under the vehicle. To illustrate this the air flowing from the front 655 of racecar 600 is split into an upper flow 660 that flows over the car and a lower flow 665 that flows under the car. The features of front wing 630 will be discussed in further detail below.

As further shown in FIG. 6, rear wing 635 may also have air that flows above it and below it. For example, an upper airflow 670 may flow over rear wing 635, while a lower airflow 680 may flow under rear wing 635. The features of rear wing 635 will be discussed in greater detail below.

In addition, as shown in FIG. 6, rear air diffuser 640 may have the airfoil configuration shown and discussed with respect to FIGS. 1-5. The enlarged view embedded in FIG. 6 illustrates the features of rear air diffuser 640. In particular, rear air diffuser 640 may have a base portion including a trailing portion 645 and an overhang portion 650. As indicated by an arrow 685, rear air diffuser 640 may be arranged to turn air flowing from under the car upwards into the void behind the car when it is moving in a forward direction. This is also illustrated in FIG. 6 by airflow 690.

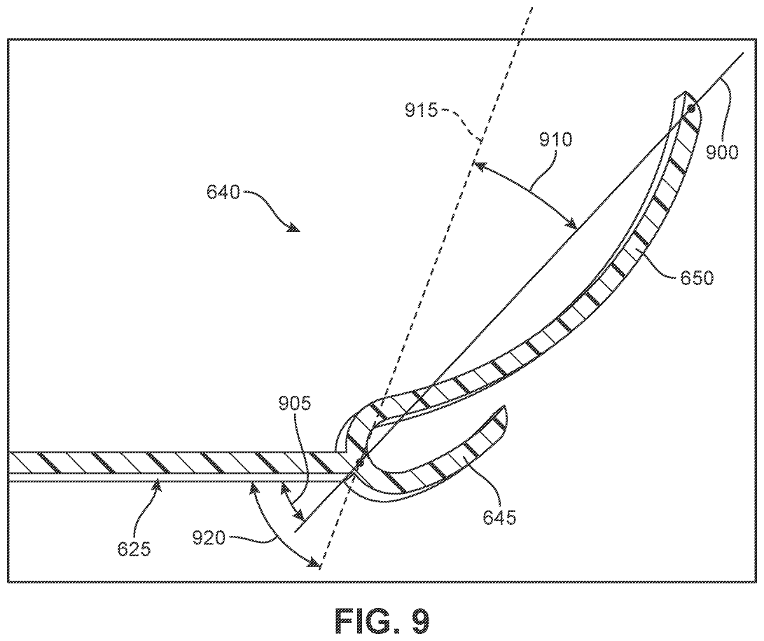

Since, as shown in FIG. 6, rear air diffuser 640 is exceptionally effective at turning the air upward behind the car to fill in the vacuum created in the vehicle's wake, many benefits can be realized by utilizing such an airfoil design for a diffuser. First, drag can be significantly reduced. As noted, the disclosed airfoil configuration can turn the air upward much more sharply than a conventional airfoil. A conventional airfoil is only effective at an attack angle of about 20 to 25 degrees. (The term “attack angle” will be addressed/defined below in conjunction with FIG. 9.) Above 20-25 degrees, the flow of air detaches from the downstream surface of the airfoil, “lift” is reduced to nothing, and the redirection of air becomes minimal. Therefore, when implemented in a diffuser, a conventional airfoil cannot be turned more than 20-25 degrees from horizontal. In contrast, the disclosed airfoil can be turned upwards of 70 degrees from horizontal and can turn the flow of air as much as 110 degrees (i.e., the air is actually redirected slightly forward). This is more than enough to turn the flow of air 90 degrees to fill in immediately behind the car. In addition, the fact that the air flow can be turned more than 90 degrees may enable the air to hug the tail of the car even at high speeds.

Second, the air flow that is directed upwards can be shot up so significantly, it can merge with the flow of air over and under a rear wing disposed at the top rear of the car. This effect is shown by an arrow 695 in FIG. 6. Merging the airflow from under the car with the airflow from over the car can reduce overall turbulence and thus reduce drag behind the car.

Third, by shooting the airflow upwards, the disclosed airfoil-shaped diffuser can direct the flow of air up over the car trailing behind. This may increase the effect of drafting, which can be preferred for racing because it facilitates passing. It also enables cars to drive closer to one another without turbulent air disrupting the downforce being created by the trailing car. This also facilitates passing, which makes for entertaining racing.

Fourth, the disclosed airfoil-shaped diffuser can reduce or prevent porpoising of the car. That is, a racecar with a conventional diffuser only facilitates the flow of air under the car so much. In order to accelerate the flow of air below the car to create downforce, the chassis is lowered significantly. At high vehicle speeds, the high speed of airflow under the car creates downforce. However, because there is so little space under the car, the slightest compression of the suspension cuts off airflow beneath the car. For example, if a bump compresses the suspension, the body of the racecar drops, bottoming out and thereby cutting off the flow of air under the car suddenly and eliminating the downforce. As a result of the downforce suddenly being eliminated (or drastically reduced) the chassis pops upward. When the car pops upward, airflow underneath the car resumes, suddenly creating downforce again and pulling the chassis downward, but the chassis overshoots a neutral position, bottoming out again and cutting off airflow, and so forth. This cycle repeats, resulting in the chassis bouncing up and down, an effect referred to as “porpoising,” since it resembles a porpoise repeatedly jumping up out of the water. Porpoising significantly destabilizes the car, making it difficult to go fast.

The disclosed airfoil-shaped diffuser, by turning the air into an area of low pressure behind the car, accelerates airflow beneath the car more so than a conventional diffuser. Therefore, the chassis does not need to sit as low to provide a high velocity airflow underneath the car. With the chassis not sitting as low, the likelihood of porpoising is greatly reduced or eliminated.

Thus, the present disclosure is directed to an air diffuser configured for use at the lower rear of a land vehicle. The air diffuser may be formed of an airfoil that, when located at the lower rear of a land vehicle, is oriented to redirect air passing under the land vehicle upward behind the land vehicle when the land vehicle is traveling in a forward direction. The airfoil has a leading edge, a trailing edge, an upper side, and a lower side. The airfoil cross-sectional shape includes a base portion including a first surface associated with the upper side and a second surface associated with the lower side; an overhang portion that extends under some of the base portion; and an elliptic portion connecting the base portion and the overhang portion adjacent the leading edge.

As discussed above with respect to FIGS. 3 and 4, the overhang portion may be curved toward the second surface of the base portion. In particular, the overhang portion comprising a first arc portion having a first radius of curvature on the lower side, and the base portion may have a trailing portion comprising a second arc portion having a second radius of curvature on the lower side that is different from the first radius of curvature. In some embodiments, the first radius of curvature may be smaller than the second radius of curvature. For example, as discussed above with respect to FIG. 4, the first radius of curvature is approximately two thirds the length of the second radius of curvature.

As also discussed with respect to FIG. 3 above, a free end of the overhang portion may be separated from the base portion by a gap, wherein the gap is substantially greater than a local thickness of the overhang portion. In some embodiments, the gap may be at least twice as large as the local thickness of the overhang portion.

FIG. 7 is a schematic perspective illustration of a rear air diffuser assembly according to an exemplary embodiment. As shown in FIG. 7, diffuser 640 may include a first endplate 700 and a second endplate 705. In addition, diffuser 640 may include a first strake 710 and a second strake 715. The endplates and strakes may provide stability by maintaining a non-lateral flow of air around the diffuser. It will be understood that the number of strakes may vary and that those having ordinary skill in the art will recognize the factors to be considered in determining how many strakes to be used as well as the size of such strakes.

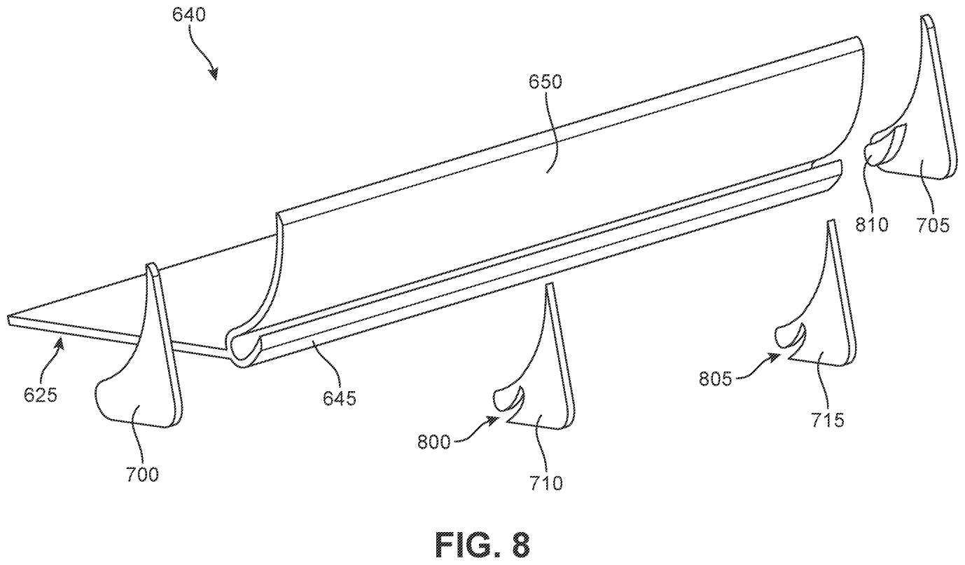

FIG. 8 is a schematic exploded view of the rear air diffuser of FIG. 7. As shown in FIG. 8, first strake 710 may include a first slot 800 configured to accommodate overhang portion 645. Similarly, second strake 715 may include a second slot 805 configured to accommodate overhang portion 645. Also, the endplates may include projections shaped to fit within overhang portion 645, such as projection 810 on second endplate 705. These components may be attached to one another via any suitable connection, such as adhesive or welding. Other structural connections between the endplates and strakes with the airfoil portion of the diffuser 640 may also be possible.

In some embodiments, the disclosed airfoil-based diffuser could be movable/controllable. For example, the diffuser can be set at different angles to effectuate different results. It will be noted that adjustment of the orientation of the disclosed airfoil a given amount has a greater affect than the same adjustment of a conventional airfoil.

FIG. 9 is a schematic cutaway cross-sectional view of the rear air diffuser of FIG. 7. As shown in FIG. 9, the disclosed airfoil-shaped aerodynamic components may be oriented at a given “angle of attack.” The present disclosure and claims utilize the expression “angle of attack,” to refer to the angle at which the component is oriented with respect to oncoming airflow. For example, as shown in FIG. 9, rear air diffuser 640 has an approximate centerline 900 that is oriented at an angle of attack 905 with respect to horizontal, which is represented here as underside 625 of the vehicle.

In some embodiments, rear air diffuser 640 may be movable/pivotable to a different angle of attack. For example, another centerline 915 is shown in phantom, representing a steeper angle of attack 920 at which rear diffuser 640 may be oriented. Double-headed arrow 910 illustrates a possible range of adjustment of the angle of attack of rear air diffuser 640.

In some embodiments, rear air diffuser 640 may be pivotable to a position in which airflow is redirected at an angle of greater than 90 degrees from horizontal such that the resulting airflow is angled slightly forward from vertical.

Those of ordinary skill in the art will readily recognize mechanisms by which the airfoil portion of rear air diffuser 640 may be pivotally attached to the vehicle. In some embodiments, rear air diffuser 640 may be manually adjustable to different angles of attack. In other embodiments, the angle of attack may be adjustable with motorized mechanism. In some embodiments, the motorized control of the adjustment mechanism may be automated. Such automated control is discussed in greater detail below.

The disclosed airfoil can be used at the front and/or rear of the car as wings to produce downforce and to produce various aerodynamic effects. First, as noted above, the airfoil may be used as the front and/or rear wings to produce downforce. Also, the front and/or rear wings can be arranged to work together with the rear diffuser to produce desired aerodynamic effects. For example, as noted above, the rear wing and the diffuser may be used to merge the flow of air behind the car.

The angle of attack of the front wing can be adjusted to direct the air over and/or under the car as desired. In addition, in some embodiments, the angle of attack may be adjustable to selectively direct more air over or under the car. The angle of attack may be based on speed, proximity to a leading car or other factors. The control of this angle may be automated or manually controllable.

It is also noteworthy that the disclosed airfoil produces more downforce at a flat angle of attack than a conventional airfoil does. Therefore, the disclosed airfoil does not need to be angled upwards to create downforce. Accordingly, the disclosed airfoil can produce downforce without causing drag like an upwardly angled wing. In addition, angling the wing upwards directs air over the car, which is not necessarily desirable for a front wing when it is preferred to get more air flowing under the car. Therefore, the disclosed airfoil, when implemented as a front wing, can produce high downforce while directing more air under the car.

In some embodiments, the present disclosure is directed to a front wing configured for use at the lower front of a land vehicle. The disclosed front wing may include an airfoil that, when located at the lower front of a land vehicle, is oriented to control the ratio of air directed over the land vehicle when the land vehicle is traveling in a forward direction to air directed under the land vehicle when the land vehicle is traveling in a forward direction. The airfoil has a leading edge, a trailing edge, an upper side, and a lower side, the airfoil cross-sectional shape including: a base portion including a first surface associated with the upper side and a second surface associated with the lower side; an overhang portion that extends under some of the base portion; and an elliptic portion connecting the base portion and the overhang portion adjacent the leading edge. The overhang portion is curved toward the second surface of the base portion.

In addition, the overhang portion may include a first arc portion having a first radius of curvature on the lower side and the base portion may include a trailing portion having a second radius of curvature on the lower side that is different from the first radius of curvature. In some embodiments, the first radius of curvature is less than the second radius of curvature. In some embodiments, the first radius of curvature may be approximately two thirds the length of the second radius of curvature. Additionally, or alternatively, a free end of the overhang portion is separated from the base portion by a gap that is substantially greater than a local thickness of the overhang portion. For example, the gap is at least twice as large as the local thickness of the overhang portion.

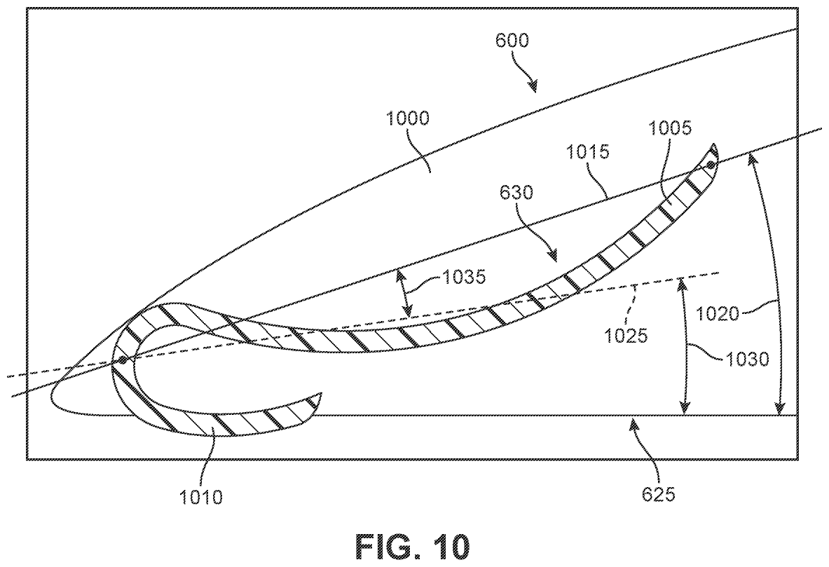

FIG. 10 is a schematic cutaway cross-sectional view of a front wing according to an exemplary embodiment. As shown in FIG. 10, racecar 600 may include a front clip including a nose cone 1000, which may include front wing 630 having the particular airfoil shape disclosed herein. That is, front wing 630 may include a base portion including a trailing portion 1005 and an overhang portion 1010.

Front wing 630 may be oriented at any angle of attack suitable for splitting the air above and below racecar 600 in the desired manner. As shown in FIG. 10, a centerline 1015 of front wing 630 may be oriented at an angle of attack 1020 with respect to the horizontal, which is represented by underside 625 of racecar 600.

In some embodiments, front wing 630 may be movable/pivotable to a different angle of attack. For example, another centerline 1025 is shown in phantom, representing a shallower angle of attack 1030 at which front wing 630 may be oriented. Double-headed arrow 1035 illustrates a possible range of adjustment of the angle of attack of front wing 630. It will be understood that front wing 630 may be adjustable by a smaller or greater amount as desired.

Those of ordinary skill in the art will readily recognize mechanisms by which front wing 630 may be pivotally attached to the vehicle. In some embodiments, front wing 630 may be manually adjustable to different angles of attack. In other embodiments, the angle of attack may be adjustable with motorized mechanism. In some embodiments, the motorized control of the adjustment mechanism may be automated. Such automated control is discussed in greater detail below.

In some embodiments, the present disclosure is directed to a rear wing configured for use at the upper rear of a land vehicle. The rear wing may include an airfoil that, when located at the upper rear of a land vehicle, is oriented to produce downforce when the land vehicle is traveling in a forward direction. The airfoil has a leading edge, a trailing edge, an upper side, and a lower side, the airfoil cross-sectional shape including: a base portion including a first surface associated with the upper side and a second surface associated with the lower side; an overhang portion that extends under some of the base portion; and an elliptic portion connecting the base portion and the overhang portion adjacent the leading edge. In some embodiments, the overhang portion may be curved toward the second surface of the base portion.

In some embodiments, the overhang portion comprises a first arc portion having a first radius of curvature on the lower side and the base portion having a trailing portion comprising a second arc portion having a second radius of curvature on the lower side that is different from the first radius of curvature. In some cases, the first radius of curvature may be less than the second radius of curvature. For example, in some embodiments, the first radius of curvature is approximately two thirds the length of the second radius of curvature.

Alternatively, or additionally, a free end of the overhang portion may be separated from the base portion by a gap that is substantially greater than a local thickness of the overhang portion. In some embodiments, the gap is at least twice as large as the local thickness of the overhang portion.

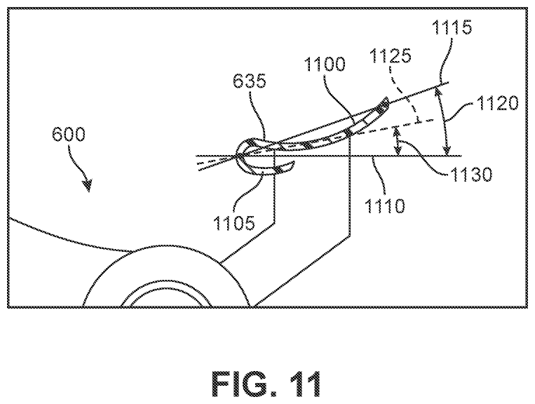

FIG. 11 is a schematic cutaway cross-sectional view of a rear wing according to an exemplary embodiment. As shown in FIG. 11, racecar 600 may include a rear wing 635 having the particular airfoil shape disclosed herein. That is, rear wing 635 may include a base portion including a trailing portion 1100 and an overhang portion 1105.

Rear wing 635 may be oriented at any angle of attack suitable for producing downforce while minimizing drag. As shown in FIG. 11, a centerline 1115 of rear wing 635 may be oriented at an angle of attack 1120 with respect to the horizontal, which is represented by a line 1110.

In some embodiments, rear wing 635 may be movable/pivotable to a different angle of attack. For example, another centerline 1125 is shown in phantom, representing a shallower angle of attack 1130 at which rear wing 635 may be oriented.

Those of ordinary skill in the art will readily recognize mechanisms by which rear wing 635 may be pivotally attached to the vehicle. In some embodiments, rear wing 635 may be manually adjustable to different angles of attack. In other embodiments, the angle of attack may be adjustable with motorized mechanism. In some embodiments, the motorized control of the adjustment mechanism may be automated. Such automated control is discussed in greater detail below.

In some embodiments, the rear air diffuser and the rear wing may be configured and arranged to merge the flow of air from underneath the vehicle with the flow of air from above the vehicle. Additionally, or alternatively, the front wing and the rear air diffuser may work together to control the flow of air underneath the vehicle. Further, the front wing and the rear wing may work together to control the flow of air over the vehicle. Moreover, the front wing, the rear wing, and the rear air diffuser may work together to control the flow of air over and under the vehicle.

In some embodiments, at least one of the front wing, rear wing, and rear air diffuser is pivotable to change the angle of attack. In order to control these components, the vehicle may include a control system including a controller including a device processor and a non-transitory computer readable medium having stored thereon instructions, executable by the device processor, to automatically control the angle of attack of the front wing, rear wing, and/or the rear air diffuser.

In some embodiments, the system may be configured to change the angle of attack of one or more of these components based upon one or more driving parameters. For example, such driving parameters upon which control may be based may include vehicle speed, vehicle acceleration, lateral gravitational forces (G-forces), vehicle location, and/or positional orientation of other aerodynamic components of the vehicle. In addition, the control of the aerodynamic components may be based on detected airflow conditions and/or vehicle behavior.

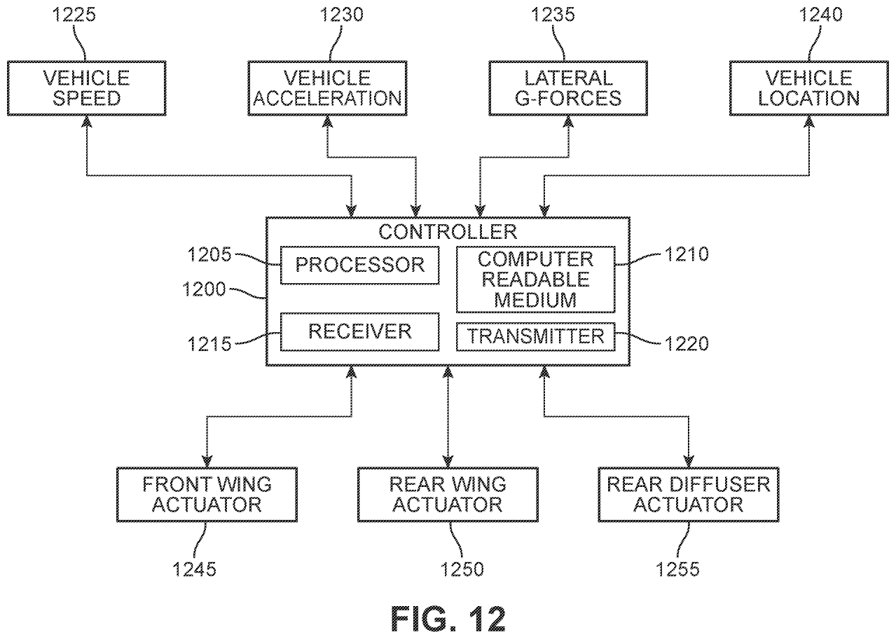

FIG. 12 is a block diagram illustrating exemplary components of an active aerodynamic system according to an exemplary embodiment. As shown in FIG. 12, the system may include a controller 1200. Controller 1200 may include various computing and communications hardware. For example, as shown in FIG. 12, controller 1200 may include a device processor 1205 and a non-transitory computer readable medium 1210 including instructions executable by device processor 1205. Computer readable medium 1210 may include any suitable computer readable medium, such as a memory, such as RAM, ROM, flash memory, or any other type of memory known in the art. Controller 1200 may include other computing hardware, such as servers, integrated circuits, displays, etc.

Further, controller 1200 may include networking hardware configured to interface with other nodes of a network, such as a LAN, WLAN, or other networks. For example, as shown in FIG. 12, controller 1200 may include a receiver 1215 and a transmitter 1220. (It will be appreciated that, in some embodiments, the receiver and transmitter may be combined in a transceiver.) Receiver 1215 and transmitter 1220 may be configured to provide communication with other nodes of the system.

Controller 1200 may be provided at any suitable location. In some cases, controller 1200 may be provided onboard the racecar. In other cases, controller 1200 may be provided in the pits for operation/monitoring by a race pit crew.

As shown in FIG. 12, controller 1200 may be configured to receive data regarding various vehicle parameters. For example, controller 1200 may be configured to received vehicle speed 1225, vehicle acceleration 1230, lateral gravitational forces (i.e., G-forces), and vehicle location 1240. Controller 1200 may be configured to control one or more of the aerodynamic components (i.e., the front wing, rear wing, and/or rear air diffuser) based on these vehicle parameters. For example, at higher speeds, the aerodynamic components may be adjusted to produce less downforce and less drag, whereas at lower speeds, the components may be adjusted to produce more downforce at a cost of higher drag. In some embodiments, the system may be configured to increase the angle of attack of the rear air diffuser in order to better fill in the vacuum produced behind the car at higher speeds. At lower speeds, the front wing and/or rear wing may be adjusted to an increased angle of attack in order to produce more downforce through corners. At higher speeds, the front wing and rear wing may be leveled out (smaller angle of attack) in order to reduce drag.

As shown in FIG. 12, controller 1200 may be configured to control a front wing actuator 1245, a rear wing actuator 1250, and/or a rear diffuser actuator 1255. As indicated by the double headed arrows connecting controller 1200 with these components, the positioning of each of these components may be fed back to controller 1200 and considered when adjusting each of the other components. That is, the system may consider the angle of attack at which each component is oriented when selecting an angle of attack for each of the other components. For example, the front wing and rear wing should be adjusted keeping in mind the relative difference in down force produced at the front and rear of the vehicle. In addition, the front wing and rear diffuser may be adjusted keeping in mind the effect on air flow under the car that is produced by each of the two components. Further, the rear wing and rear diffuser may be adjusted keeping in mind how each of these two components directs the airflow behind the car, e.g., to merge the flow of air from below with that from above the car.

It will also be noted that the aerodynamic components discussed herein, namely the front wing, rear wing, and rear air diffuser, may also work in conjunction with the body of the vehicle. That is, the aerodynamic effects of the vehicle body may be combined with those of the aerodynamic components discussed herein. Thus, when positioning the aerodynamic components, the aerodynamics of the vehicle body may be taken into account.

In some embodiments, the control of the aerodynamic components may be based on detected airflow conditions. For example, in some cases, the flow of air around different parts of the vehicle may be detected using one or more sensors. Such sensors may include vibration sensors, accelerometers, wind speed sensors, pressure sensors, and/or G-sensors. This may be used to determine how much air is flowing over or under the vehicle at a given time, enabling the vehicle to modify the angle of attack of one or more of the aerodynamic components to achieve the desired airflow balance. In addition,

In some embodiments, the control of the aerodynamic components may be based on detected vehicle behavior. For example, the vehicle may be configured to detect porpoising. This may be done by detecting how the vehicle behaves at the onset of porpoising. For example, the compression pattern of the vehicle suspension may be monitored to determine when porpoising is occurring or is at risk of occurring. In some embodiments, other sensing systems may detect the behavior of the vehicle, such as vibration sensors, G-sensors, accelerometers, etc. Data from such detection systems may be utilized to control the aerodynamic components to stop or prevent porpoising or other adverse vehicle dynamics. In some embodiments, a steering position sensor may be considered by the system. For example, in some cases, the aerodynamic components may be oriented for minimal drag when the steering is straight ahead, and oriented for increased down force as the steering becomes more and more deviated from straight ahead.

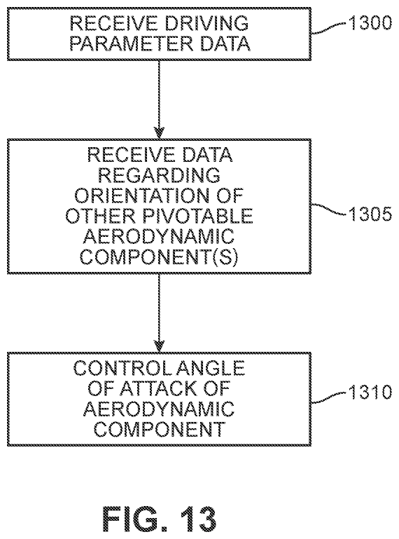

FIG. 13 is a flowchart illustrating steps of an exemplary method of operating the system shown in FIG. 12. As shown in FIG. 13, at a first step 1300, the controller may receive driving parameter data. In addition, at step 1305, the controller may receive data regarding the orientation of one or more other pivotable aerodynamic components. Further, as shown in FIG. 13, at step 1310, the system may control the angle of attack of a given aerodynamic component.

While various embodiments of the invention have been described, the description is intended to be exemplary, rather than limiting, and it will be apparent to those of ordinary skill in the art that many more embodiments and implementations are possible that are within the scope of the invention. Any element of any embodiment may be substituted for another element of any other embodiment or added to another embodiment except where specifically excluded. Accordingly, the invention is not to be restricted except in light of the attached claims and their equivalents. Also, various modifications and changes may be made within the scope of the attached claims.

1. An air diffuser configured for use at the lower rear of a land vehicle, comprising:
an airfoil that, when located at the lower rear of a land vehicle, is oriented to redirect air passing under the land vehicle upward behind the land vehicle when the land vehicle is traveling in a forward direction;
wherein the airfoil has a leading edge, a trailing edge, an upper side, and a lower side, the airfoil cross-sectional shape including:
a base portion including a first surface associated with the upper side and a second surface associated with the lower side;
an overhang portion that extends under some of the base portion; and
an elliptic portion connecting the base portion and the overhang portion adjacent the leading edge.

2. The air diffuser of claim 1, wherein the overhang portion is curved toward the second surface of the base portion.

3. The air diffuser of claim 2, wherein the overhang portion comprises a first arc portion having a first radius of curvature on the lower side and the base portion having a trailing portion comprising a second arc portion having a second radius of curvature on the lower side that is different from the first radius of curvature.

4. The air diffuser of claim 3, wherein the first radius of curvature is smaller than the second radius of curvature.

5. The air diffuser of claim 4, wherein the first radius of curvature is approximately two thirds the length of the second radius of curvature.

6. The air diffuser of claim 2, wherein a free end of the overhang portion is separated from the base portion by a gap, and wherein the gap is substantially greater than a local thickness of the overhang portion.

7. The air diffuser of claim 6, wherein the gap is at least twice as large as the local thickness of the overhang portion.

8. A front wing configured for use at the lower front of a land vehicle, comprising:
an airfoil that, when located at the lower front of a land vehicle, is oriented to control the ratio of air directed over the land vehicle when the land vehicle is traveling in a forward direction to air directed under the land vehicle when the land vehicle is traveling in a forward direction;
wherein the airfoil has a leading edge, a trailing edge, an upper side, and a lower side, the airfoil cross-sectional shape including:
a base portion including a first surface associated with the upper side and a second surface associated with the lower side; and
an overhang portion that extends under some of the base portion;
an elliptic portion connecting the base portion and the overhang portion adjacent the leading edge;
wherein the overhang portion is curved toward the second surface of the base portion.

9. The front wing of claim 8, wherein the overhang portion comprises a first arc portion having a first radius of curvature on the lower side and the base portion comprising a trailing portion having a second radius of curvature on the lower side that is different from the first radius of curvature.

10. The front wing of claim 9, wherein the first radius of curvature is less than the second radius of curvature.

11. The front wing of claim 10, wherein the first radius of curvature is approximately two thirds the length of the second radius of curvature.

12. The front wing of claim 8, wherein a free end of the overhang portion is separated from the base portion by a gap, and wherein the gap is substantially greater than a local thickness of the overhang portion.

13. The front wing of claim 12, wherein the gap is at least twice as large as the local thickness of the overhang portion.

14. A rear wing configured for use at the upper rear of a land vehicle, comprising:
an airfoil that, when located at the upper rear of a land vehicle, is oriented to produce downforce when the land vehicle is traveling in a forward direction;
wherein the airfoil has a leading edge, a trailing edge, an upper side, and a lower side, the airfoil cross-sectional shape including:
a base portion including a first surface associated with the upper side and a second surface associated with the lower side;
an overhang portion that extends under some of the base portion; and
an elliptic portion connecting the base portion and the overhang portion adjacent the leading edge.

15. The rear wing of claim 14, wherein the overhang portion is curved toward the second surface of the base portion.

16. The rear wing of claim 14, wherein the overhang portion comprises a first arc portion having a first radius of curvature on the lower side and the base portion having a trailing portion comprising a second arc portion having a second radius of curvature on the lower side that is different from the first radius of curvature.

17. The rear wing of claim 16, wherein the first radius of curvature is less than the second radius of curvature.

18. The rear wing of claim 17, wherein the first radius of curvature is approximately two thirds the length of the second radius of curvature.

19. The rear wing of claim 14, wherein a free end of the overhang portion is separated from the base portion by a gap, and wherein the gap is substantially greater than a local thickness of the overhang portion.

20. The rear wing of claim 19, wherein the gap is at least twice as large as the local thickness of the overhang portion.
